(19) United States
(12) Patent Application Publication
(10) Pub. No.: US 2005/0140809 A1
(43) Pub. Date: Jun. 30, 2005

(54) Picture quality evaluation device and controlling method thereof

(75) Inventor: Boo-taeck Lim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/019,206

(22) Filed: Dec. 23, 2004

(30) Foreign Application Priority Data
Dec. 24, 2003 (KR) 2003-96390

(51) Int. Cl. H04N 5/222

(52) U.S. Cl. 348/333.01

(57) ABSTRACT

An image quality evaluation device including a display, a video signal supplier to supply a video signal to the display, a camera to photograph an image displayed on the display according to the video signal, an image quality evaluator to evaluate an image quality property from photographing information of the image photographed by the camera, and a synchronization signal detector to detect an image display period according to the video signal supplied from the video signal supplier, and to transfer the image display period to the camera, wherein the camera synchronizes a photographing period with the image display period.

### CROSS-REFERENCE TO RELATED APPLICATIONS

This application claims the benefit of Korean Patent Application No. 2003-96390, filed Dec. 24, 2003, in the Korean Intellectual Property Office, the disclosure of which is incorporated herein by reference.

### BACKGROUND OF THE INVENTION

1. Field of the Invention

The present invention relates to an image quality evaluation device and a controlling method thereof, and, particularly, to an image quality evaluation device and a controlling method thereof comprising a display, a video signal supplier supplying a video signal to the display, a camera photographing an image displayed on the display on a basis of the video signal, and an image quality evaluator evaluating an image property by receiving information on the image photographed by the camera.

2. Description of the Related Art

A cathode ray tube (CRT) of a television, a liquid crystal display (LCD), or a monitor is an output apparatus receiving an image signal from the outside and processing it into a proper video signal to display an image. These apparatuses require inspection or evaluation on image quality during a manufacturing process or an inspection process.

Korea patent publication No. 1999-49447 discloses an inspection apparatus of image quality adjustment for a CRT display and a method thereof. It was devised to solve a problem that a conventional method of a visual inspection with bare eyes of an inspector was not quantized.

Further, as shown in FIG. 1, the inspection apparatus disclosed in the above Korea patent publication comprises a CRT display 10 to be inspected, a video signal supplier 13 supplying the video signal to the CRT display 10, a charge coupled device (CCD) camera 15 photographing an image displayed on the CRT display 10, an image processor 17 processing the image photographed by the CCD camera 15 into an image and outputting the image to a controller 18 by pixels, a controller 18 calculating a brightness value of a predetermined area of each image and determining whether the image quality adjustment function is qualified or not on a basis of the brightness value, and a display 19 displaying a result of the determination.

Accordingly, it can be determined whether the image quality adjustment function is qualified or not by calculating and processing brightness values by pixels statistically with information taken by photographing the image displayed on the CRT display.

However, as the conventional technology does not use synchronization of a photographing period of the CCD camera and a displaying period of the image displayed on the CRT display, some of the images may not be photographed during a continuous photographing within a predetermined time.

Also, the conventional technology only displays the result of the determination which indicates whether the image quality adjustment function is qualified by counting the number of pixels that satisfies a predetermined criterion, and comparing the number with a criterion number to be qualified. Accordingly, further detailed and various image quality evaluation is not available.

### SUMMARY OF THE INVENTION

Accordingly, it is an aspect of the present invention to provide providing an image quality evaluation device, and a controlling method thereof, providing a quantized image quality evaluation result.

Another aspect of the present invention is to provide an image quality evaluation device, and a controlling method thereof, supplied with information on an inspected image easily and precisely, and without additional process, by synchronizing a photographing period and a screen display period.

Further, another aspect of the present invention is to provide an image quality evaluation device, and a controlling method thereof, showing an image quality evaluation result that is more precise, and able to be displayed in more various forms that are more convenient for a user to recognize.

Additional aspects and advantages of the invention will be set forth in part in the description which follows and, in part, will be obvious from the description, or may be learned by practice of the invention.

The foregoing and/or other aspects of the present invention are achieved by an image quality evaluation device comprising a display, a video signal supplier to supply a video signal to the display, a camera to photograph an image displayed on the display according to the video signal, an image quality evaluator to evaluate an image quality property from photographing information of the image photographed by the camera, and a synchronization signal detector to detect an image display period according to the video signal supplied from the video signal supplier, and to transfer the image display period to the camera, wherein the camera synchronizes a photographing period with the image display period.

According to an aspect of the invention, the video signal supplied to the synchronization signal detector may comprise a horizontal synchronization signal and a vertical synchronization signal.

According to an aspect of the invention, the image quality evaluation device may further comprise a photographing information compensator, provided between the camera and the image quality evaluator, to receive the photographing information and compensate the photographing information with the image quality property outputted from the display.

According to an aspect of the invention, the image quality evaluator may comprise an information converter to convert the photographing information compensated by the photographing information compensator according to the image quality property to be evaluated by pixels, and align the converted photographing information in a pre-set form; and an evaluation information display to display the converted photographing information outputted from the information converter.

According to an aspect of the invention, the image quality evaluator may further comprise an evaluation area selector to select an evaluation area according to a user input.

According to an aspect of the invention, the evaluation area selector may further comprise a photographing information display to display the compensated photographing information, and an evaluation area detector to detect the evaluation area selected by a user with the photographing information display.

According to an aspect of the invention, the image quality evaluator may further comprise a criterion information memory to store criterion information regarding the image quality property, and the evaluation information display displays the converted photographing information along with the corresponding criterion information superimposed.

According to an aspect of the invention, the image quality evaluation device may further comprise an additional camera to photograph the image displayed on the display according to the video signal; and a camera selector to select one of the camera and the additional camera to provide the photographing information.

According to another aspect of the present invention, the above and/or other aspects may be also achieved by a method of controlling an image quality evaluation device comprising a display, a video signal supplier to supply a video signal to the display, a camera to photograph an image displayed on the display according to the video signal, and an image quality evaluator to evaluate an image quality property from photographing information of the image photographed by the camera, the method comprising: detecting an image display period from the video signal supplier; and synchronizing a photographing period of the camera with the image display period.

According to an aspect of the invention, the video signal supplied to the synchronization signal detector may comprise a horizontal synchronization signal and a vertical synchronization signal.

According to an aspect of the invention, the control method of the image quality evaluation device may further comprise compensating the photographing information to provide the photographing information in a form that the image quality evaluator requires.

According to an aspect of the invention, the control method of the image quality evaluation device may further comprise converting the compensated photographing information according to the image quality property to be evaluated by pixels; and displaying the converted photographing information by aligning the converted photographing information in a pre-set form.

According to an aspect of the invention, the control method of the image quality evaluation device may further comprise selecting an evaluation area according to a user input before displaying the aligned converted photographing information.

According to an aspect of the invention, the selecting the evaluation area may comprise displaying the compensated photographing information; inputting selectively the evaluation area of the displayed photographing information; and detecting the evaluation area selected.

According to an aspect of the invention, the control method of the image quality evaluation device may further comprise setting the image quality property to be evaluated as brightness or color temperature, wherein the displaying the aligned converted photographing information comprises displaying a graph showing the brightness or the color temperature of corresponding pixels along a transverse direction coordinate of the pixels.

According to an aspect of the invention, the control method of the image quality evaluation device may further comprise setting the image quality property to be evaluated as a maximum brightness, a minimum brightness, or an average brightness, wherein the displaying the aligned converted photographing information comprises displaying corresponding coordinates or corresponding values of the maximum brightness, the minimum brightness, or the average brightness of the pixels in a form of a table.

According to an aspect of the invention, the control method of the image quality evaluation device may further comprise setting the image quality property to be evaluated as brightness statistics, wherein the displaying the aligned converted photographing information comprises displaying quantities of the pixels having each of corresponding brightness values in a form of a graph.

According to an aspect of the invention, the control method of the image quality evaluation device may further comprise setting the image quality property to be evaluated as hue or color saturation, wherein the displaying the aligned converted photographing information comprises displaying R, G, B information and color saturation of the pixels in a form of a graph.

According to an aspect of the invention, the control method of the image quality evaluation device may further comprise providing a criterion information memory to store criterion information regarding the image quality property, and displaying the converted photographing information along with the corresponding criterion information.

According to an aspect of the invention, the control method of the image quality evaluation device may further comprise providing an additional camera to photograph the image displayed on the display according to the video signal; and selecting one of the camera and the additional camera to provide the photographing information.

### BRIEF DESCRIPTION OF THE DRAWINGS

These and/or other aspects and advantages of the present invention will become apparent and more readily appreciated from the following description of the aspects, taken in conjunction with the accompany drawings of which:

FIG. 1 is a control block diagram of an image quality evaluation device according to conventional technology;

FIG. 2 is a control block diagram of an image quality evaluation device according to an embodiment of the present invention;

FIG. 3 is a detailed block diagram of an image quality evaluator according to the embodiment of the present invention shown in FIG. 2;

FIG. 4 illustrates an example in which an evaluation area is selected from the image quality evaluator displayed with converted photographing information;

FIG. 5 illustrates an evaluation result of an image quality property corresponding to the evaluation area;

FIG. 6 illustrates another example in which an evaluation area is selected from the image quality evaluator displayed with converted photographing information;

FIGS. 7, 8, and 9 illustrate other examples representing the evaluation result of the image quality property corresponding to the evaluation area.

FIG. 10 is a flow chart illustrating a control process of an image quality evaluation device according to an embodiment of the present invention.

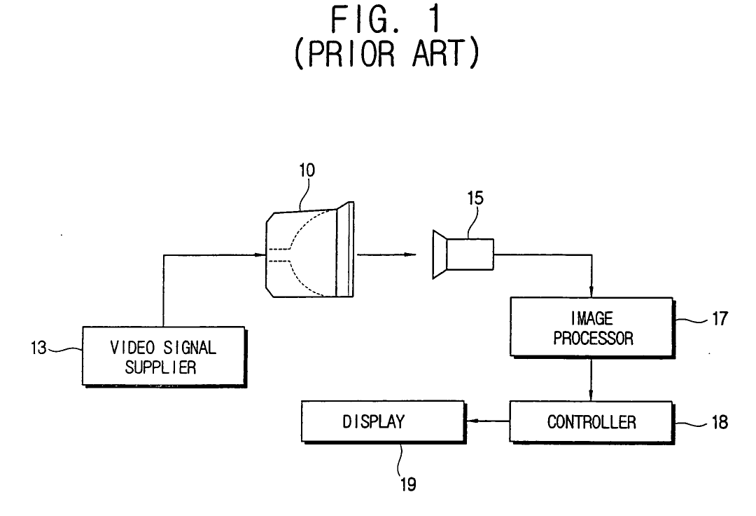

### DETAILED DESCRIPTION OF THE PREFERRED EMBODIMENTS

Reference will now be made in detail to the aspects of the present invention, examples of which are illustrated in the accompanying drawings, wherein like reference numerals refer to like elements throughout. The aspects are described below in order to explain the present invention by referring to the figures.

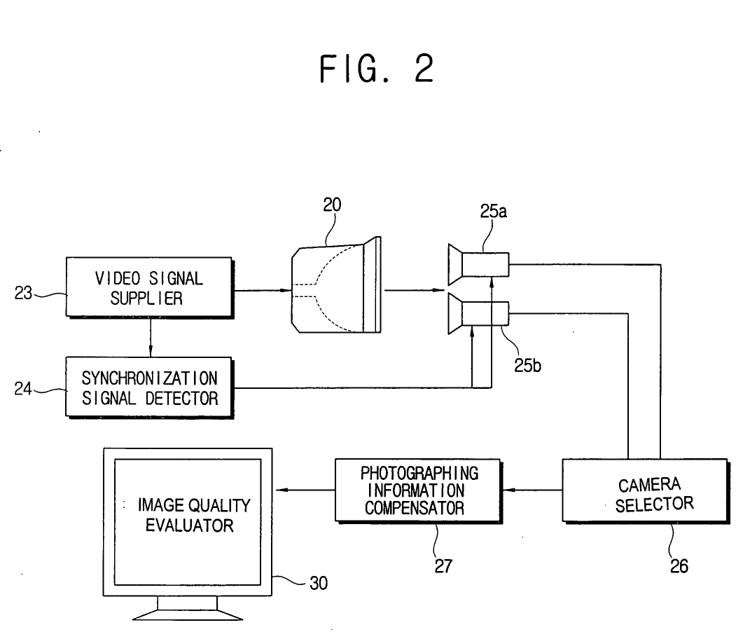

FIG. 2 is a block diagram of an image quality evaluation device according to an embodiment of the present invention. As shown therein, an image quality evaluation device according to this embodiment of the present invention comprises a display 20, a video signal supplier 23 supplying a video signal to the display 20, a synchronization signal detector 24 detecting an image display period on a basis of the video signal and transferring it to a camera 25a, the camera 25a photographing an image displayed on the display 20 according to the video signal with the image display period, and an image quality evaluator 30 inputted with photographing information on the image photographed by the camera 25a and evaluating an image quality property.

Also, the image quality evaluation device according to this embodiment of the present invention further comprises a photographing information compensator 27 receiving the photographing information and compensating the photographing information in a form required by the image quality evaluator 30, an additional camera 25b, and a camera selector 26 selecting one of the camera 25a and the additional camera 25b to input the photographing signal.

The video signal supplier 23 supplies the video signal so that a predetermined image is displayed on the display 20. Herein, the predetermined image may be a plurality of images set previously so as to represent an image quality which is more readily evaluated. The video signal supplier 23 may be a video player, a digital video disc (DVD) player replaying a video disc, a DVD storing the predetermined image to be displayed, etc.

The synchronization signal detector 24 detects the image display period according to the video signal from the video signal supplier 23, and transfers it to the camera 25a and the additional camera 25b.

In this case, the synchronization signal detector 24 is inputted with a video signal that is a composite signal supplied to the display 20 from the video signal supplier 23 at the same time, and separates a horizontal synchronization signal and a vertical synchronization signal to supply to the camera 25a and 25b.

The camera 25a receiving the horizontal synchronization signal and the vertical synchronization signal photographs the image displayed on the display 20 by synchronizing the horizontal synchronization signal and the vertical synchronization signal with the photographing period.

Accordingly, in a case in which continuously provided images are photographed over a predetermined time, all the images displayed can be photographed. Accordingly, all the photographed images are stored in a predetermined space provided in the image quality evaluator 30 for reevaluation at any time for convenience of the user.

The camera 25a and the additional camera 25b are CCD cameras photographing the image displayed on the display 20 and supplying it to the image quality evaluator 30. They use two individual CCD cameras properly adjusted to be compatible with a signal transfer method and resolution of the display 20. Herein, one CCD camera properly adjusted for conditions of the display 20 to be evaluated may be provided.

The camera selector 26 is a selector to select one of the camera 25a and the additional camera 25b from which to receive the photographing signal. It can be manipulated easily by a user interface, such as a selection window, provided by the image quality evaluator 30.

The photographing information compensator 27 compensates the photographic information according to a difference between the photographing information outputted from the cameras 25a and 25b and the image information outputted by the display 20 and recognized by the user.

In other words, because the photographing information photographed by the CCD camera and outputted to the image quality evaluator 30 is information regarding standard RGB (SRGB) per pixel, the photographing information compensator 27 calculates the SRGB per pixel by reflecting a compensation coefficient to modify the photographing information into an RGB that the display can output.

The image quality evaluator 30 evaluates the image quality property by receiving the photographing information (or compensated photographing information) of the image photographed by the cameras 25a or 25b.

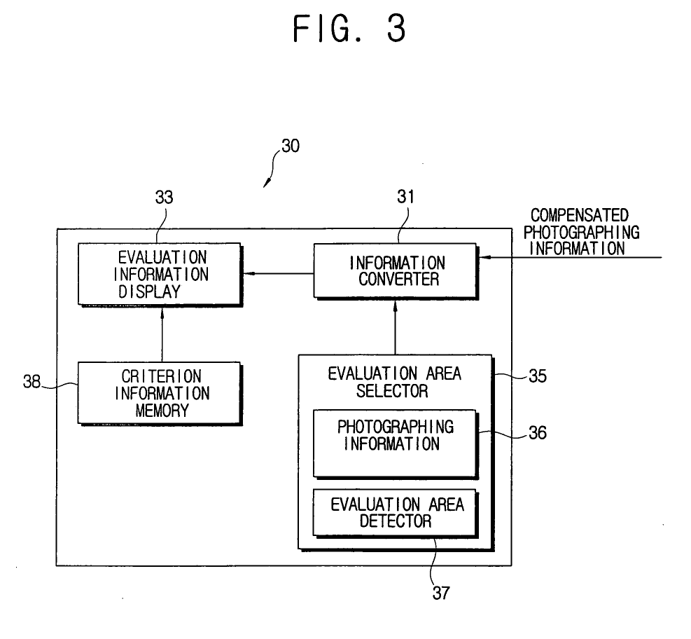

As shown in FIG. 3, the image quality evaluator 30 comprises an information converter 31 converting the photographing information which has been compensated by the photographing information compensator 27 by pixels according to the image quality property to be evaluated and aligns the information in a predetermined form, an evaluation information display 33 displaying the photographing information outputted from the information converter 31, and an evaluation area selector 35 selecting an evaluation area according to the user's manipulation.

The information converter 31 converts the compensated photographing information by pixels according to the image quality property to be evaluated and aligns the information in a predetermined form.

Herein, the image quality property to be evaluated comprises brightness distribution of a predetermined area, maximum brightness within the predetermined area, minimum brightness, average brightness, the number of pixels per each brightness, brightness contrast, color (or hue) distribution within the predetermined area, color saturation distribution within the predetermined area, color temperature within the predetermined area, and time to remove the after-image. These properties can be achieved by applying a predetermined conversion equation that calculates the property of the RGB information per pixel such as brightness, color (or hue), color temperature, degree of noise, degree of after-image, and color shift, or by applying the predetermined conversion equation after photographing with a predetermined photographing condition such as image, a photographing time, and a photographing angle.

As an example, if the image quality property to be evaluated is the brightness within the predetermined area, brightness is calculated using the predetermined equation on a basis of the RGB information corresponding to each pixel. An x-coordinate corresponding to each pixel and a coordinate value corresponding to the calculated brightness of the pixels may be stored in order to plot a graph to illustrate the brightness of the pixels.

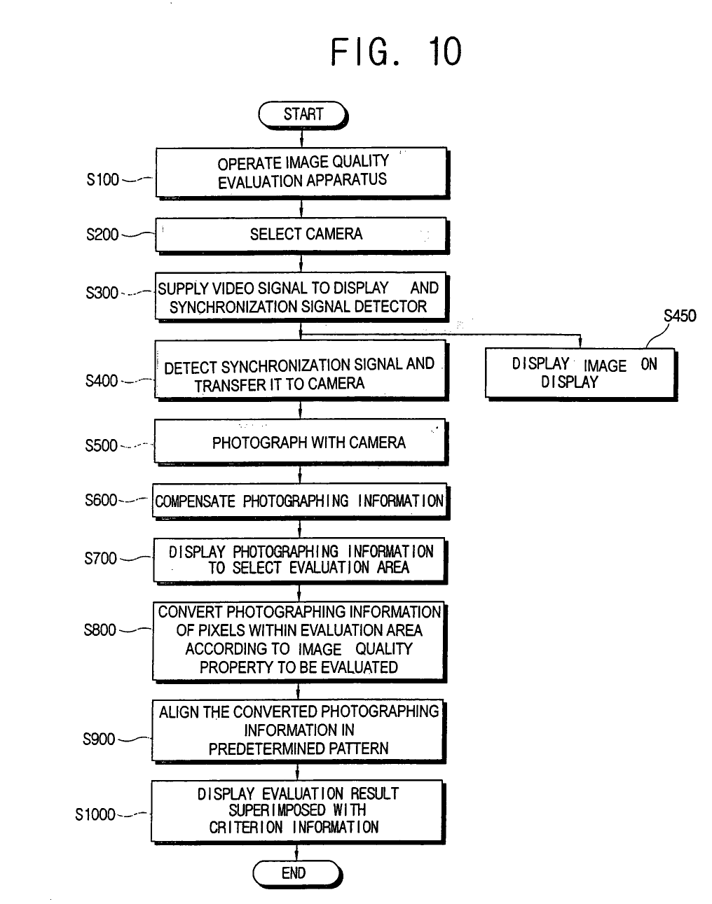

Various examples will be shown in a description of a control process of the image quality evaluation device with reference to FIG. 10.

The evaluation information display 33 displays the photographing information outputted from the information converter 31. Herein, the evaluation information display 33 may be a display provided in the image quality evaluator 30 or an additional printer connected to the image quality evaluator 30.

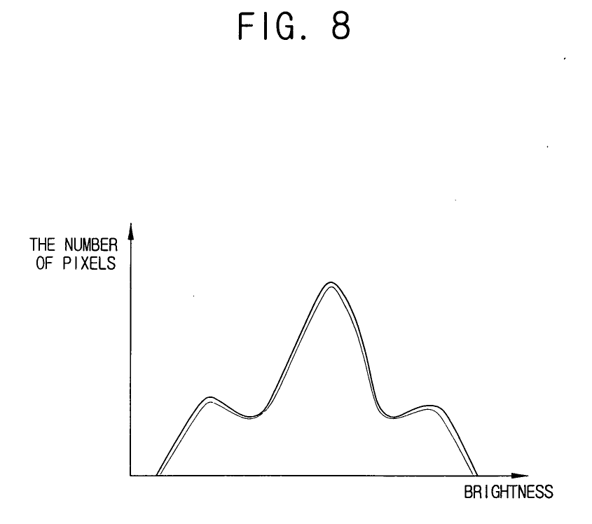

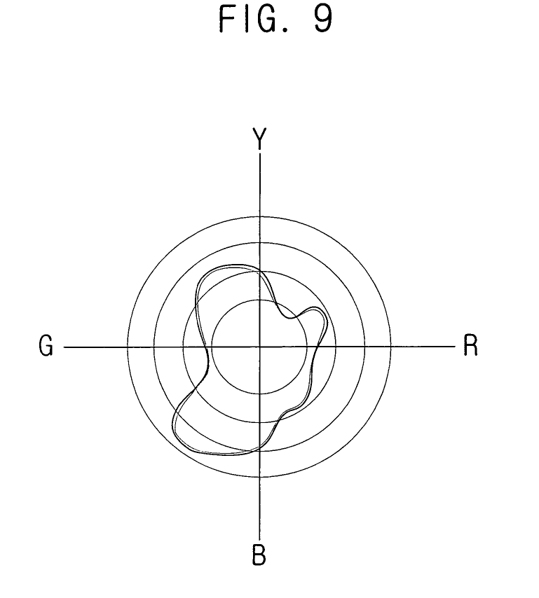

As an example, the photographing information of the brightness outputted from the information converter 31 may be represented as a graph having x-coordinates corresponding to the pixels and y-coordinates corresponding to the calculated brightness of the respective pixels. Herein, as shown in FIGS. 8, and 9, criterion information per image quality property stored in a criterion information memory 38 may be displayed along with the converted photographing information.

More various examples will be shown in a description of the control process of the image quality evaluation device with reference to FIG. 10.

The evaluation area selector 35 is provided so that the evaluation area can be selected according to the user's manipulation. It may comprise a photographing information display 36 displaying the compensated photographing information, and an evaluation area detector 37 detecting the evaluation area selected by the user with the photographing information display 36.

The evaluation area to be evaluated may be one whole image displayed on the display 20, or a predetermined area out of the whole image, according to the selection of the user.

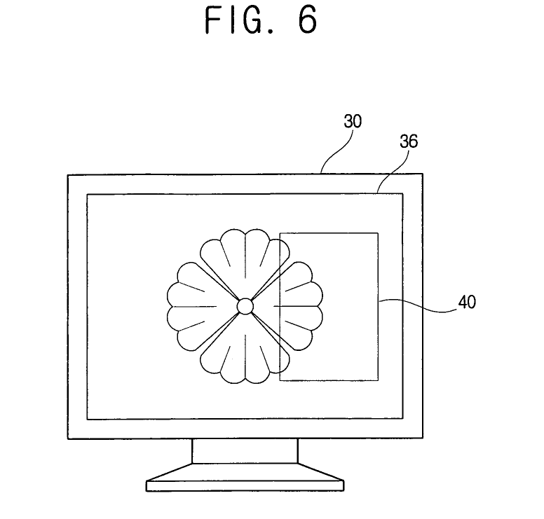

As shown in FIG. 6, after the image displayed on the display 20 is photographed by the camera 25a or 25b, the compensated photographing information is displayed through the photographing information display 36 of the image quality evaluator 30. If the user selects a predetermined evaluation area 40 out of the displayed image using an input device such as a key or a mouse, the evaluation area detector 37 detects the evaluation area selected by the manipulation of the input device by pixels.

Herein, the photographing information display 36 may be a general display, or may employ the evaluation information display 33.

FIG. 10 is a flow chart illustrating a control process of an image quality evaluation device according to an embodiment of the present invention. As shown therein, after initiating the image quality evaluation device according to the embodiment of the present invention by applying power to the video signal supplier 23, the display 20, the cameras 25a or 25b, and the image quality evaluator 30 at operation S100, the user selects the camera to be used for photographing the image displayed on the display 20 through the camera selector 26 at operation S200.

At operations S300 and S400, the synchronization signal detector 24 separates the horizontal and vertical synchronization signals and transfers them to the cameras 25a and 25b according to the video signal inputted from the video signal supplier 23. At operation S450, the display 20 displays the image on a basis of the video signal inputted from the video signal supplier 23. At operation S500, the image displayed on the display 20 is photographed corresponding to the horizontal and vertical synchronization signals.

Herein, the provided video signal may be provided in a way that displays different images according to the image quality properties to be evaluated. Also, the video signal may be provided in a way that displays an identical image, including the plurality of horizontal and vertical synchronization signals, for a predetermined time and repeating the provided different images periodically. Also, a different image may be provided for each image display period, that is, a horizontal and vertical synchronization signal representing one frame displaying one image completely.

Hereinbelow, an image evaluation process that is implemented using the photographing information will be described.

At operation S600, the photographing information photographed by the cameras 25a or 25b, in which the RGB information for each pixel is stored, is compensated into the RGB information used in the display 20. The compensated photographing information is displayed by the photographing information display 36 of the image quality evaluator 30.

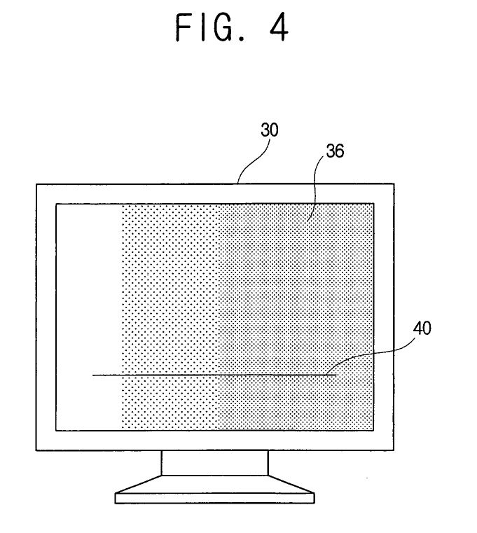

At operation S700, the user can select the evaluation area 40 to be evaluated from the photographing information displayed through the photographing information display 36 of the image quality evaluator 30 as a line as shown in FIG. 4, or as a boundary encircling a predetermined area as shown in FIG. 6.

At operation S800, the photographing information of the pixels within the evaluation area selected from the compensated photographing information is chosen and converted according to the image quality property to be evaluated.

Herein, the image quality property to be evaluated comprises one or more of a brightness distribution of a predetermined area, maximum brightness within the predetermined area, minimum brightness, average brightness, the number of pixels per each brightness, brightness contrast, color (or hue) distribution within the predetermined area, color saturation distribution within the predetermined area, color temperature within the predetermined area, and time to remove the after-image. These properties can be achieved by applying a predetermined conversion equation that calculates the property to the RGB information per pixel, such as brightness, color (or hue), color temperature, degree of noise, degree of after-image, and color shift, or by applying the predetermined conversion equation after photographing with a predetermined photographing condition such as image, a photographing time, and a photographing angle.

At operation S900, the photographing information of the pixels converted by applying the predetermined conversion equation according to the image quality property to be evaluated is aligned in a form that is convenient for the user to recognize.

Herein, the forms convenient for the user to recognize may comprise a table, a graph, a histogram, and any other shape that illustrates information statistically.

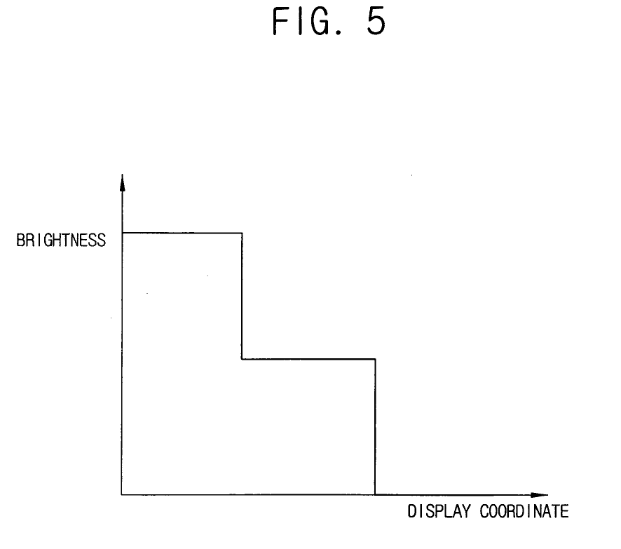

As an example, FIG. 5 illustrates the photographing information on the image for the brightness distribution in FIG. 4 by aligning. It represents corresponding brightness a transverse direction coordinate of the pixels.

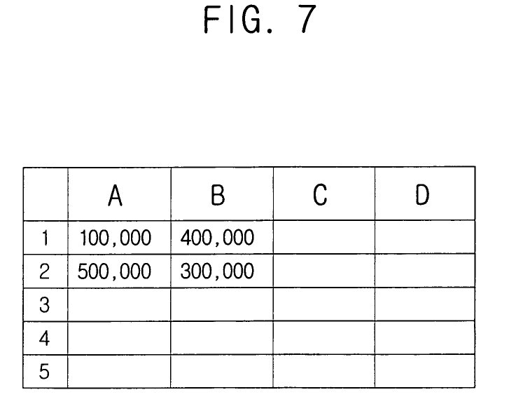

FIG. 7 illustrates a table which is one of the aligning display methods used for representing a coordinate and a corresponding value with the maximum brightness, minimum brightness, and average brightness.

FIG. 8 shows the photographing information as a histogram representing the number of pixels per each brightness value after calculating the brightness value by each pixel.

FIG. 9 illustrates the photographing information of each pixel as a graph represented by showing saturation of each color on an axis of a cone and yellow (Y), red (R), green (G), and blue (B) on a radial axis after calculating the color (hue) value and color saturation by a pixel.

Herein, FIGS. 8, and 9 indicate two lines, one of which is the photographing information photographed by the camera and converted by the predetermined conversion equation, and the other of which is pre-set criterion information.

In this way, by displaying the photographing information to be evaluated, as well as the criterion information together in one graph or one histogram, the user can recognize the evaluation result easily and accurately.

The evaluation result of the image quality property evaluated using the image quality device or the image evaluation method according to this embodiment of the present invention may be used in improving a part having a particular function, and in deciding whether the corresponding part is unqualified or not. Also, it can be used in improving the performance of the display.

As described above, according to an embodiment of the present invention, by synchronizing the screen display period and the photographing period, the photographing information to be inspected can be provided easily and accurately, without an additional process. Also, the quantized, accurate, and various image quality evaluation results are provided in a form that the user can recognize easily.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An image quality evaluation device, comprising:
a display:
a video signal supplier to supply a video signal to the display;
a camera to photograph an image displayed on the display according to the video signal;
an image quality evaluator to evaluate an image quality property from photographing information of the image photographed by the camera; and
a synchronization signal detector to detect an image display period according to the video signal supplied from the video signal supplier, and to transfer the image display period to the camera;
wherein the camera synchronizes a photographing period with the image display period.

2. The image quality evaluation device according to claim 1, wherein the video signal supplied to the synchronization signal detector comprises a horizontal synchronization signal and a vertical synchronization signal.

3. The image quality evaluation device according to claim 1, further comprising a photographing information compensator, provided between the camera and the image quality evaluator, to receive the photographing information and compensate the photographing information with the image quality property outputted from the display.

4. The image quality evaluation device according to claim 3, wherein the image quality evaluator comprises:
an information converter to convert the photographing information compensated by the photographing information compensator according to the image quality property to be evaluated by pixels, and align the converted photographing information in a pre-set form; and
an evaluation information display to display the converted photographing information outputted from the information converter.

5. The image quality evaluation device according to claim 4, wherein the image quality evaluator further comprises an evaluation area selector to select an evaluation area according to a user input.

6. The image quality evaluation device according to claim 5, wherein the evaluation area selector comprises:
a photographing information display to display the compensated photographing information; and
an evaluation area detector to detect the evaluation area selected by a user with the photographing information display.

7. The image quality evaluation device according to claim 4, wherein the image quality evaluator further comprises a criterion information memory to store criterion information regarding the image quality property; and
the evaluation information display displays the converted photographing information along with the corresponding criterion information.

8. The image quality evaluation device according to claim 2, further comprising a photographing information compensator, provided between the camera and the image quality evaluator, to receive the photographing information and compensate the photographing information with the image quality property outputted from the display.

9. The image quality evaluation device according to claim 8, wherein the image quality evaluator comprises:
an information converter to convert the photographing information compensated by the photographing information compensator according to the image quality property to be evaluated by pixels, and align the converted photographing information in a pre-set form; and
an evaluation information display to display the converted photographing information outputted from the information converter.

10. The image quality evaluation device according to claim 9, wherein the image quality evaluator further comprises an evaluation area selector to select an evaluation area according to a user input.

11. The image quality evaluation device according to claim 10, wherein the evaluation area selector comprises:
a photographing information display to display the compensated photographing information; and
an evaluation area detector to detect the evaluation area selected by a user with the photographing information display.

12. The image quality evaluation device according to claim 9, wherein the image quality evaluator further comprises a criterion information memory to store criterion information regarding the image quality property; and
the evaluation information display displays the converted photographing information along with the corresponding criterion information.

13. The image quality evaluation device according to claim 1, further comprising:
an additional camera to photograph the image displayed on the display according to the video signal; and
a camera selector to select one of the camera and the additional camera to provide the photographing information.

14. The image quality evaluation device according to claim 1, wherein the image quality property to be evaluated is at least one of a brightness distribution of a predetermined area, maximum brightness within the predetermined area, minimum brightness within the predetermined area, average brightness within the predetermined area, a number of pixels per brightness areas in the predetermined area, brightness contrast, color or hue distribution within the predetermined area, color saturation distribution within the predetermined area, color temperature within the predetermined area, and amount of time to remove an after-image.

15. A method of controlling an image quality evaluation device comprising a display, a video signal supplier to supply a video signal to the display, a camera to photograph an image displayed on the display according to the video signal, and an image quality evaluator to evaluate an image quality property from photographing information of the image photographed by the camera, the method comprising:
detecting an image display period from the video signal supplier; and
synchronizing a photographing period of the camera with the image display period.

16. The method of controlling the image quality evaluation device according to claim 15, wherein the video signal supplied to the synchronization signal detector comprises a horizontal synchronization signal and a vertical synchronization signal.

17. The method of controlling the image quality evaluation device according to claim 16, further comprising compensating the photographing information to provide the photographing information in a form that the image quality evaluator requires.

18. The method of controlling the image quality evaluation device according to claim 17, further comprising:
converting the compensated photographing information according to the image quality property to be evaluated by pixels; and
displaying the converted photographing information by aligning the converted photographing information in a pre-set form.

19. The method of controlling the image quality evaluation device according to claim 18, further comprising selecting an evaluation area according to a user input before displaying the aligned converted photographing information.

20. The method of controlling the image quality evaluation device according to claim 19, wherein the selecting the evaluation area comprises:
displaying the compensated photographing information;
inputting selectively the evaluation area of the displayed photographing information; and
detecting the evaluation area selected.

21. The method of controlling the image quality evaluation device according to claim 20, further comprising setting the image quality property to be evaluated as at least one of brightness, color temperature, maximum brightness, minimum brightness, average brightness, brightness statistics, hue, and color saturation;
wherein the displaying the aligned converted photographing information comprises displaying a graph showing the set image quality property.

22. The method of controlling the image quality evaluation device according to claim 18, further comprising:
providing a criterion information memory to store criterion information regarding the image quality property; and
displaying the converted photographing information along with the corresponding criterion information.

23. An image quality evaluation device to evaluate an image quality of a display, comprising:
a camera to photograph an image displayed on the display;
wherein the camera is synchronized with a video signal received by the display, so that a photographing period of the camera is synchronized with an image display period of the display.
